(19) United States
(12) Patent Application Publication
(10) Pub. No.: US 2024/0373286 A1
(43) Pub. Date: Nov. 7, 2024

(54) DOWNLINK DATA CONGESTION DETECTION FOR LOW-LATENCY SERVICES IN WIRELESS COMMUNICATION NETWORKS

(71) Applicant: T-MOBILE INNOVATIONS LLC, Overland Park, KS (US)

(72) Inventors: Zheng Fang, McLean, VA (US); Zheng Cai, Fairfax, VA (US)

(21) Appl. No.: 18/310,358

(22) Filed: May 1, 2023

(51) Int. Cl. H04W 28/02; H04W 28/22

(52) U.S. Cl. CPC H04W 28/0289; H04W 28/22

(57) ABSTRACT

Various embodiments comprise a wireless communication network to proactively notify congestion control systems in response to downlink data congestion. The wireless communication network comprises an access node and an application server. The access node wirelessly exchanges user data with a wireless user device and exchanges the user data with a network user plane for delivery to an application server. The access node detects a data queue for downlink user data transferred by the application server and received from the network user plane and indicates the data queue to the network user plane for delivery to the application server. The application server receives the indication, generates additional user data, and transfers the additional user data based on a congestion control scheme. The access node exchanges the additional user data with the network user plane for delivery to the application server and wirelessly exchanges the additional user data with the wireless user device.

### TECHNICAL FIELD

Various embodiments of the present technology relate to congestion detection, and more specifically, to notifying application servers when downlink congestion occurs for Low Latency, Low Loss, Scalable Throughput (L4S) data services.

### BACKGROUND

Wireless communication networks provide wireless data services to wireless user devices. Exemplary wireless data services include machine-control, internet-access, media-streaming, online gaming, and social-networking. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Low Latency, Low Loss, Scalable Throughput (L4S) is a network architecture that enables applications to receive low latency and high data rate communications with dynamic rate adaption for a stable Quality-of-Experience (QoE). Maintaining stable QoE is important for preserving the user experience in latency sensitive L4S applications like live video broadcast, video conferencing, Extended Reality (XR), Mixed Reality (MR), Augmented Reality (AR), and Virtual Reality (VR) applications. L4S systems utilize dynamic rate adaption algorithms at the application layer to ensure the latency requirements for the L4S applications are met. The dynamic rate adaption algorithms are hosted by L4S capable application servers and take network data congestion, particularly RAN data congestion, as an input to generate a congestion control output. The congestion control output modifies the network traffic pattern to preserve latency. The deployment of L4S architecture in wireless communication networks is not uniform. A non-L4S capable user device that begins a data session with an L4S capable application server cannot receive server-side L4S congestion control support. When the non-L4S capable user device does not receive server-side L4S congestion support, the QoE of the data session decreases. Due to the large number and diverse array of user device types in wireless communication networks, implementing L4S functionality in the user devices is expensive and time consuming.

Unfortunately, wireless communication networks do not effectively notify application server congestion control systems when downlink data congestion occurs. Moreover, the wireless communication networks do not efficiently respond to downlink congestion for latency sensitive data services like L4S.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions to detect data congestion in Radio Access Networks (RANs). Some embodiments comprise a method of operating a wireless communication network to proactively notify congestion control systems in response to downlink data congestion. The method comprises an access node wirelessly exchanging user data with a wireless user device. The method further comprises the access node exchanging the user data with a network user plane for delivery to an application server. The method further comprises the access node detecting a data queue for downlink user data transferred by the application server and received from the network user plane. The method further comprises the access node indicating the data queue to the network user plane for delivery to the application server. The method further comprises the application server receiving the indication, generating additional user data, and transferring the additional user data based on a congestion control scheme. The method further comprises the access node exchanging the additional user data with the network user plane for delivery to the application server. The method further comprises the access node wirelessly exchanging the additional user data with the wireless user device.

Some embodiments comprise a wireless communication network configured to proactively notify congestion control systems in response to downlink data congestion. The wireless communication network comprises an access node and an application server. The access node wirelessly exchanges user data with a wireless user device and exchanges the user data with a network user plane for delivery to an application server. The access node detects a data queue for downlink user data transferred by the application server and received from the network user plane and indicates the data queue to the network user plane for delivery to the application server. The application server receives the indication, generates additional user data, and transfers the additional user data based on a congestion control scheme. The access node exchanges the additional user data with the network user plane for delivery to the application server and wirelessly exchanges the additional user data with the wireless user device.

Some embodiments comprise a method of operating a Radio Access Network (RAN) to proactively notify congestion control systems in response to downlink data congestion. The method comprises radio circuitry wirelessly exchanging user data with a wireless user device. The method further comprises RAN circuitry exchanging the user data with a network user plane for delivery to an application server. The method further comprises the RAN circuitry detecting a data queue for downlink user data transferred by the application server and received from the network user plane. The method further comprises the RAN circuitry indicating the data queue to the network user plane for delivery to the application server wherein the application server receives the indication and transfers additional user data based on a congestion control scheme. The method further comprises the RAN circuitry exchanging the additional user data with the network user plane for delivery to the application server. The method further comprises the radio circuitry wirelessly exchanging the additional user data with the wireless user device.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a wireless communication network to proactively notify a congestion control system in response to downlink data congestion.

FIG. 2 illustrates an exemplary operation of the wireless communication network to proactively notify a congestion control system in response to downlink data congestion.

FIG. 3 illustrates a wireless communication network to proactively notify a congestion control system in response to downlink data congestion.

FIG. 4 illustrates an exemplary operation of the wireless communication network to proactively notify a congestion control system in response to downlink data congestion.

FIG. 5 illustrates an exemplary operation of the wireless communication network to proactively notify a congestion control system in response to downlink data congestion.

FIG. 6 illustrates a Fifth Generation (5G) wireless communication network to proactively notify a congestion control system in response to downlink data congestion.

FIG. 7 illustrates the 5G User Equipment (UE) in the 5G communication network.

FIG. 8 illustrates a 5G Radio Access Network (RAN) in the 5G wireless communication network.

FIG. 9 illustrates a Network Function Virtualization Infrastructure (NFVI) and Application Server (AS) in the 5G wireless communication network.

FIG. 10 further illustrates the NFVI and AS in the 5G wireless communication network.

FIG. 11 illustrates an exemplary operation of the 5G wireless communication network to proactively notify a congestion control system in response to downlink data congestion.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

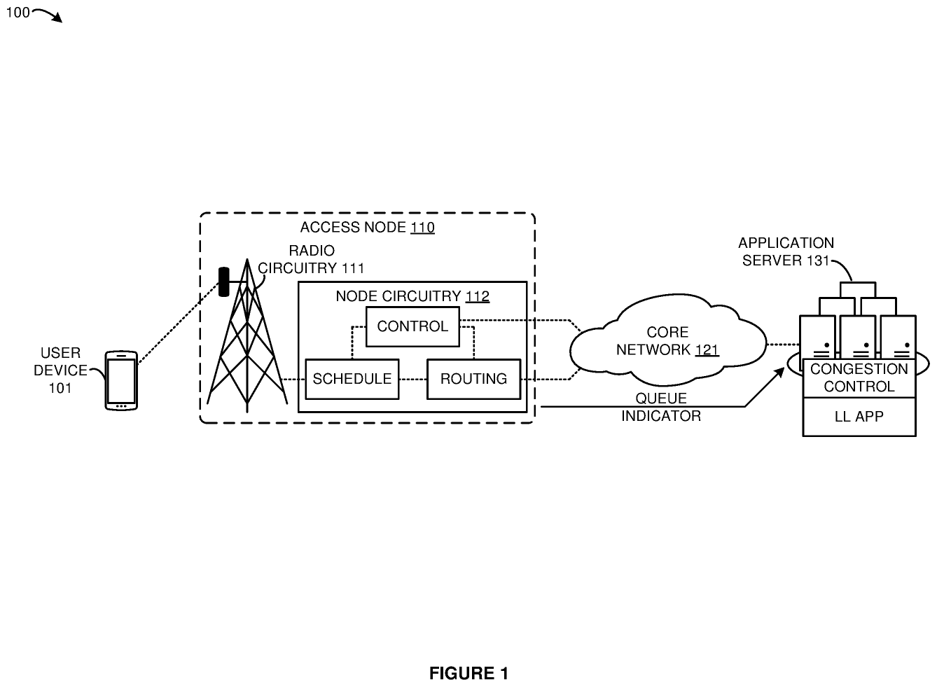

FIG. 1 illustrates wireless communication network 100 to proactively notify congestion control systems in response to downlink data congestion. Wireless communication network 100 delivers services like machine communications, internet-access, media-streaming, or some other wireless communications product to user devices. Wireless communication network 100 comprises user device 101, access node 110, core network 121, and Application Server (AS) 131. Access node 110 comprise radio circuitry 111 and node circuitry 112. Node circuitry 112 comprises network applications for node control (CONTROL), data scheduling (SCHEDULE), and data routing (ROUTING). AS 131 hosts a congestion control application and a low-latency application (LL APP). In other examples, wireless network communication network 100 may comprise additional or different elements than those illustrated in FIG. 1.

Various examples of network operation and configuration are described herein. In some examples, access node 110 wirelessly exchanges user data with user device 101. Access node 110 exchanges the user data with core network 121. Core network 121 exchanges the user data with AS 131. For example, node circuitry 112 may exchange user data for a low latency data service with a network user plane in core network 121 which in turn exchanges the low latency user data with AS 131. Access node 110 measures a queue status for downlink data traffic transferred by AS 131 over core network 121. For example, the scheduling application in node circuitry 112 may detect there exists more downlink data to transmit than available air resources. Access node 110 indicates the downlink queue to AS 131 over core network 131. AS 131 receives the queue indication generated by access node 110, generates additional downlink data, and transfers the downlink data based on a congestion control scheme. For example, the congestion control application hosted by AS 131 may reduce the downlink data rate to user device 101 to maintain the latency requirements of the data session. Access node 110 wirelessly exchanges additional user data with user device 101. Access node 110 exchanges the additional user data with core network 121. Core network 121 exchanges the user data with AS 131.

Wireless communication network 100 provides wireless data services to user device 101. Exemplary user devices include phones, computers, vehicles, robots, and sensors. Access node 110 exchanges wireless signals with user device 101 over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). Access node 110 is connected to core network 121 over backhaul data links. Access node 110 exchanges network signaling and user data with network elements in core network 121. Access node 110 may comprise wireless access points, Radio Access Networks (RANs), edge computing systems, or other types of wireless/wireline access systems to provide the wireless/wireline links, backhaul data links, and/or edge computing services between user device 101 and core network 121.

Access node 110 may comprise Radio Units (RUs), Distributed Units (DUs) and Centralized Units (CUs). For example, radio circuitry 111 may comprise an RU and node circuitry 112 may comprise a DU and a CU. The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 121. The CUs handle higher wireless network layers like the Radio Resource Control (RRC), Service Data Adaption Protocol (SDAP), and Packet Data Convergence Protocol (PDCP). The CUs are coupled to network functions in core network 121.

Core network 121 and AS 131 are representative of computing systems that provide wireless data services to user device 101 over access node 110. Exemplary computing systems comprise data centers, edge computing networks, cloud computing networks, application servers, and the like. The computing systems of core network 121 store and execute the network functions to provide wireless data services to user device 101 over access node 110. Exemplary network functions include Access and Mobility Management Function (AMF), Session Management Function (SMF), and User Plane Function (UPF). Core network 121 may comprise a Fifth Generation Core (5GC) architecture and/or an Evolved Packet Core (EPC) architecture.

The computing systems of AS 131 store and execute applications to provide low latency data services and to implement congestion control functionality. In response to receiving the queue indication generated by node circuitry 112 and received over core network 121, the congestion control application hosted by AS 131 implements a congestion control algorithm. The congestion control algorithm receives inputs from the queue indication like queue existence, amount of queued data, current data rate, data latency, and the like. The congestion control algorithm generates an output to alleviate downlink access node congestion based on the set of inputs from the queue indication. For example, the congestion control output may comprise a reduction in downlink data transfer by the AS 131 to reduce the amount of queued data in access node 110 and preserve downlink latency to user device 101.

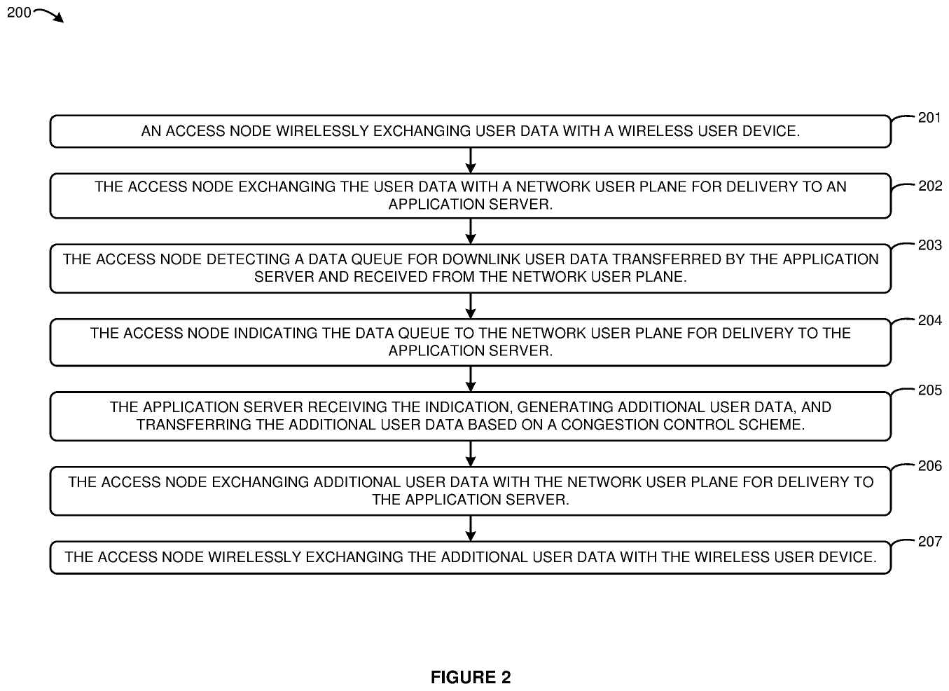

FIG. 2 illustrates process 200. Process 200 comprises an exemplary operation of wireless communication network 100 to proactively notify congestion control systems in response to downlink data congestion. The operation may vary in other examples. The operations of process 200 comprise an access node wirelessly exchanging user data with a wireless user device (step 201). The operations further comprise the access node exchanging the user data with a network user plane for delivery to an application server (step 202). The operations further comprise the access node detecting a data queue for downlink user data transferred by the application server and received from the network user plane (step 203). The operations further comprise the access node indicating the data queue to the network user plane for delivery to the application server (step 204). The operations further comprise the application server receiving the indication, generating additional downlink user data, and transferring the additional user data based on a congestion control scheme (step 205). The operations further comprise the access node exchanging additional user data with the network user plane for delivery to the application server (step 206). The operations further comprise the access node wirelessly exchanging the additional user data with the wireless user device (step 207).

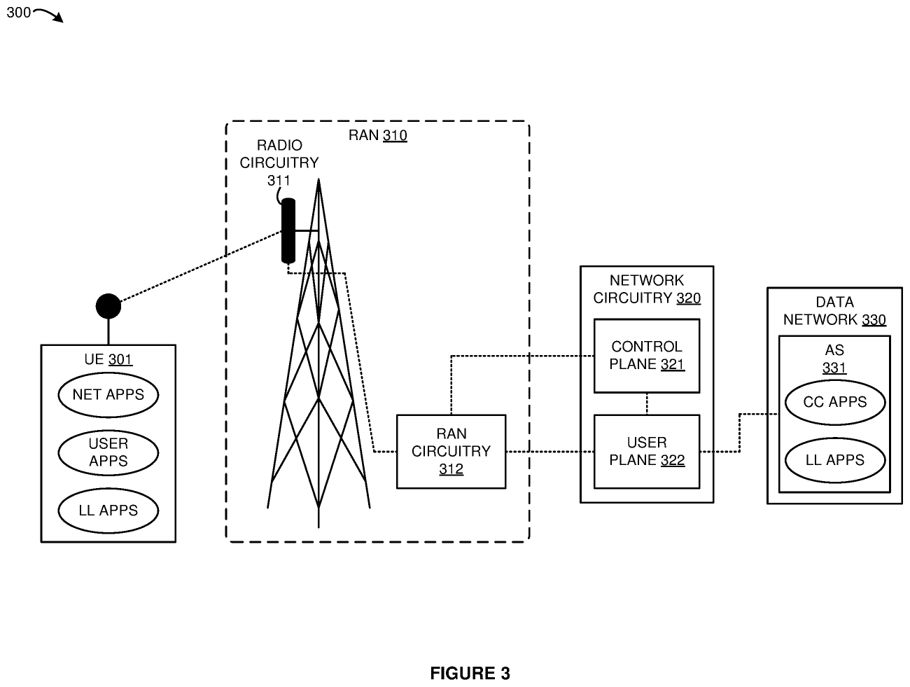

FIG. 3 illustrates wireless communication network 300 network to proactively notify congestion control systems in response to downlink data congestion. Wireless communication network 300 is an example of wireless network 100, however network 100 may differ. Wireless communication network 300 comprises User Equipment (UE) 301, RAN 310, network circuitry 320, and data network 330. UE 301 comprises network applications (NET APPS), user applications (USER APPS), and low-latency applications (LL APPS). RAN 310 comprises radio circuitry 311 and RAN circuitry 312. Network circuitry 320 comprises control plane 321 and user plane 322. Data network 330 comprises AS 331. AS 331 comprises congestion control applications (CC APPS) and low-latency applications (LL APPS). In other examples, wireless network 300 may comprise additional or different elements than those illustrated in FIG. 3.

In some examples, radio circuitry 311 wirelessly exchanges user data with UE 301 and RAN circuitry 112 exchanges the user data with user plane 322 for delivery to AS 331. For example, RAN 310 may wirelessly transfer downlink user data for the user applications and low-latency applications generated by AS 331 and may wirelessly receive uplink user data for the user applications and low-latency applications generated by UE 301. RAN circuitry 312 monitors for downlink data congestion for the data session of UE 301. For example, RAN circuitry 312 may determine when the amount of available air resources to transfer downlink data over a given time period is less than the amount of downlink data to transfer for the time period. When RAN circuitry 312 detects downlink data queue, RAN circuitry 312 generates and transfers a queue indication to user plane 322. User plane 322 receives the queue indication and forwards the indication to AS 331. For example, RAN circuitry 312 may generate a queue report that indicates the existence of the downlink queue, the current downlink latency, the current downlink data rate, and the downlink queue size.

AS 331 receives the queue indication and the congestion control application responsively implements a congestion control scheme for downlink user data generated by AS 331 to alleviate the downlink data queue in RAN 310. The congestion control application executes one or more congestion control algorithms that use the queue indication as an input to generate a congestion control output. The congestion control output may comprise a decrease in downlink data transmission, a temporary stoppage of downlink data transmission, an altercation to downlink data rate, data type prioritization and/or some other type of output to reduce the amount of queued data and maintain service latency for UE 301. Exemplary congestion control algorithms include Transmission Control Protocol (TCP) congestion control algorithms like Bottleneck Bandwidth and Round-trip propagation time (BBR). The low-latency application hosted by AS 331 generates additional downlink user data and transfers the user data based on the congestion control output generated by the congestion control application. Exemplary low-latency applications comprise Latency, Low Loss, Scalable Throughput (L4S) applications for live video upload, video conferencing, Extended Reality (XR), Mixed Reality (MR), Augmented Reality (AR), or Virtual Reality (VR). RAN circuitry 312 exchanges additional user data with AS 331 over user plane 322. Radio circuitry 311 wirelessly exchanges additional user data with UE 301.

Advantageously, wireless communication network 300 efficiently notifies AS 331 when downlink data queues occur. Moreover, wireless communication network 300 effectively implements downlink congestion control, even when UE 301 lacks congestion reporting capabilities.

UE 301 and RAN 310 communicate over links using wireless/wired technologies like 5GNR, LTE, LP-WAN, WIFI, Bluetooth, and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface. RAN 310, network circuitry 320, and data network 330 communicate over various links that use metallic links, glass fibers, radio channels, or some other communication media. The links use Fifth Generation Core (5GC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 may comprise a phone, vehicle, computer, sensor, drone, robot, or another type of data appliance with wireless and/or wireline communication circuitry. Although RAN 310 is illustrated as a tower, RAN 310 may comprise another type of mounting structure (e.g., a building), or no mounting structure at all. RAN 310 comprises a Fifth Generation (5G) RAN, LTE RAN, gNodeB, eNodeB, NB-IoT access node, LP-WAN base station, wireless relay, WIFI hotspot, Bluetooth access node, and/or another wireless or wireline network transceiver. UE 301 and RAN 310 comprise antennas, amplifiers, filters, modulation, analog/digital interfaces, microprocessors, software, memories, transceivers, bus circuitry, and the like. Control plane 321 comprises network functions like AMF, SMF, and the like. User plane 322 comprises network functions like UPF and the like. Data network 330 is representative of a data endpoint that for UE 301.

UE 301, RAN 310, network circuitry 320, and data network 330 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, Solid State Drives (SSD), Non-Volatile Memory Express (NVMe) SSDs, Hard Disk Drives (HDDs), and/or the like. The memories store software like operating systems, user applications, radio applications, network functions, and multimedia functions. The microprocessors retrieve the software from the memories and execute the software to drive the operation of wireless communication network 300 as described herein.

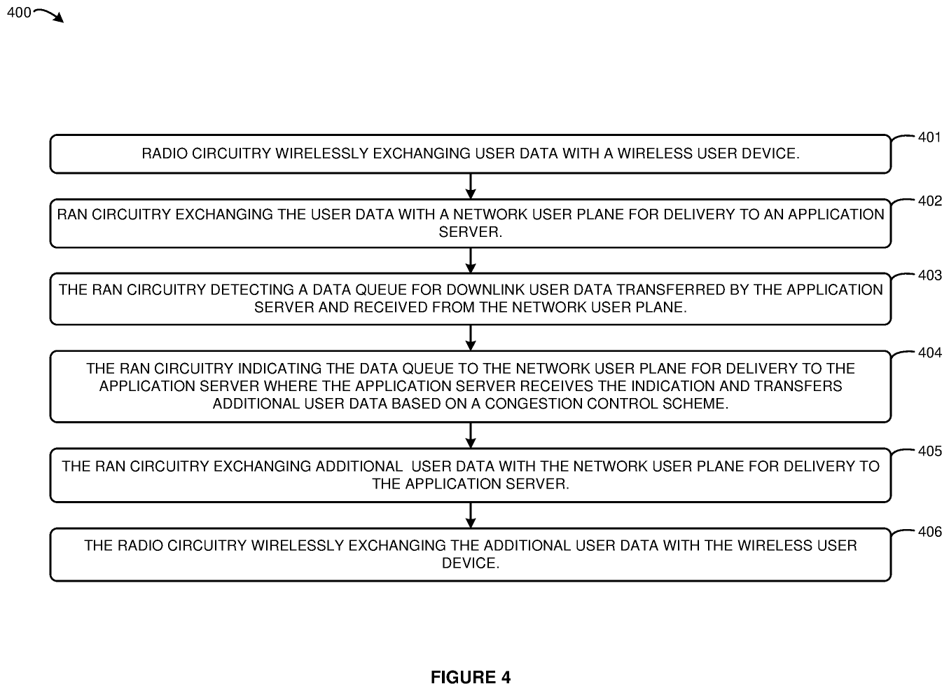

FIG. 4 illustrates process 400. Process 400 comprises an exemplary operation of wireless communication network 300 to proactively notify congestion control systems in response to downlink data congestion. The operations of process 400 comprise radio circuitry wirelessly exchanging user data with a wireless user device (step 401). The operations further comprise RAN circuitry exchanging the user data with a network user plane for delivery to an application server (step 402). The operations further comprise the RAN circuitry detecting a data queue for downlink user data transferred by the application server and received from the network user plane (step 403). The operations further comprise the RAN circuitry indicating the data queue to the network user plane for delivery to the application server where the application server receives the indication and transfers additional user data based on a congestion control scheme (step 404). The operations further comprise the RAN circuitry exchanging additional user data with the network user plane for delivery to the application server (step 405). The operations further comprise the radio circuitry wirelessly exchanging the additional user data with the wireless user device (step 406).

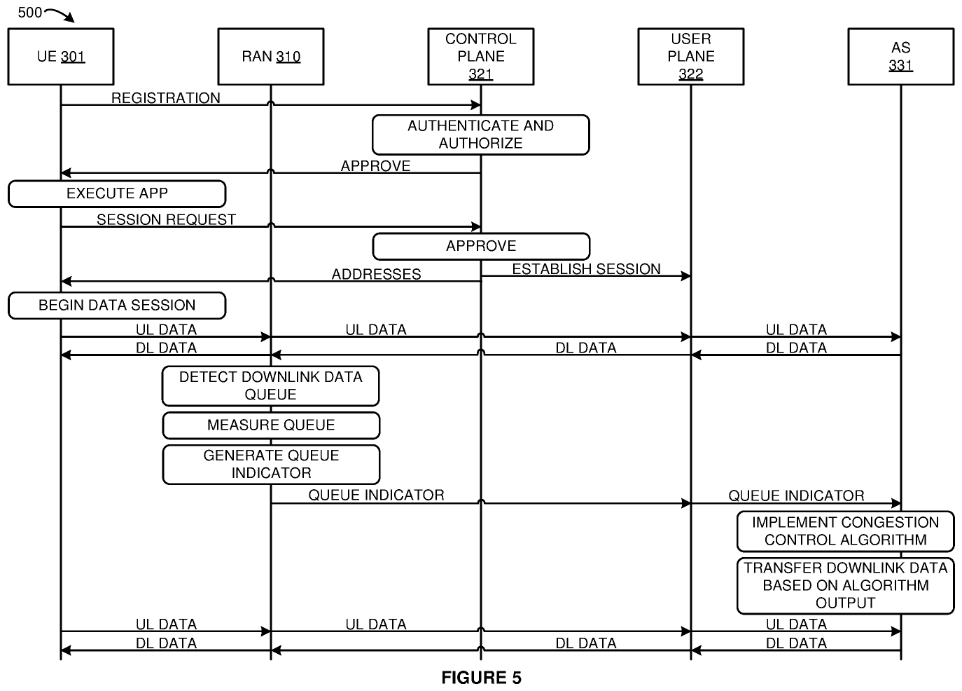

FIG. 5 illustrates process 500. Process 500 comprises an exemplary operation of wireless communication network 300 to proactively notify congestion control systems in response to downlink data congestion. The operation may vary in other examples. In operation, UE 301 transfers a registration request for data services to control plane 321 over RAN 310. For example, the network applications of UE 301 may drive the radio circuitry of UE 301 to wirelessly transfer the registration request. Control plane 321 authenticates and authorizes UE 301 for wireless data services. Control plane 321 transfers a registration approval to UE 301. UE 301 executes user applications and low latency applications. In response, UE 301 transfers a session request for low latency data services to control plane 321. Control plane 321 approves the requested data sessions. Control plane 321 controls user plane 322 to establish the requested data sessions. Control plane 321 transfers network addresses for user plane 322 and AS 331 to UE 301. UE 301 begins the data sessions and wirelessly transfers uplink user data to RAN 310. RAN 310 transfers the uplink (UL) user data to user plane 322. User plane 322 transfers the uplink user data to AS 331. AS 331 generates and transfers downlink (DL) user data to user plane 322. User plane 322 transfers the downlink user data to RAN 310. RAN 310 wirelessly transfers the downlink user data to UE 301.

RAN 310 monitors downlink data latency for UE 301 for the low-latency type data session to detect downlink data congestion through RAN 310. RAN 310 periodically measures for a downlink data queue. RAN 310 may measure queue metrics like latency, data rate, queue size, and estimated queue time to detect the downlink queue. For example, a congestion detection application resident in RAN circuitry 312 may determine an Explicit Congestion Notification (ECN) counter exceeds a threshold value to detect when the downlink data queue forms. In addition to indicating the existence of the data queue, RAN 310 may generate and transfer queue report that characterizes the amount of queued downlink data, the current downlink data rate, a delta between the current data rate and an expected data rate, a queue time, a latency, and/or other metrics characterizing the downlink data congestion in RAN 310. RAN 310 generates and transfers a queue indication to user plane 332. User plane 322 forwards the queue indication to AS 331.

AS 331 receives the queue indication. The congestion control application hosted by AS 331 executes a congestion control algorithm to process the queue indication. The algorithm outputs a priority schedule to govern downlink data transmission based on the queue indication. The congestion control application prioritizes transferring user data for low latency applications over user data for other types of user applications. For example, the low-latency application hosted by AS 331 may generate and transfer data packets for an L4S XR service to provide the L4S XR service to UE 301. AS 331 may transfer the data packets for the L4S service before transferring other types of data packets for other applications hosted by AS 331 based on the data priority. In doing so, AS 331 may maintain the latency requirements for the L4S XR application and alleviate downlink queue conditions in RAN 310. AS 331 generates and transfers additional downlink user data to user plane 322 based on the algorithm output. User plane 322 transfers the additional downlink user data to RAN 310. RAN 310 wirelessly transfers the additional downlink user data to UE 301. UE 301 wirelessly transfers additional uplink user data to RAN 310. RAN 310 transfers the uplink user data to user plane 322. User plane 322 transfers the uplink user data to AS 331.

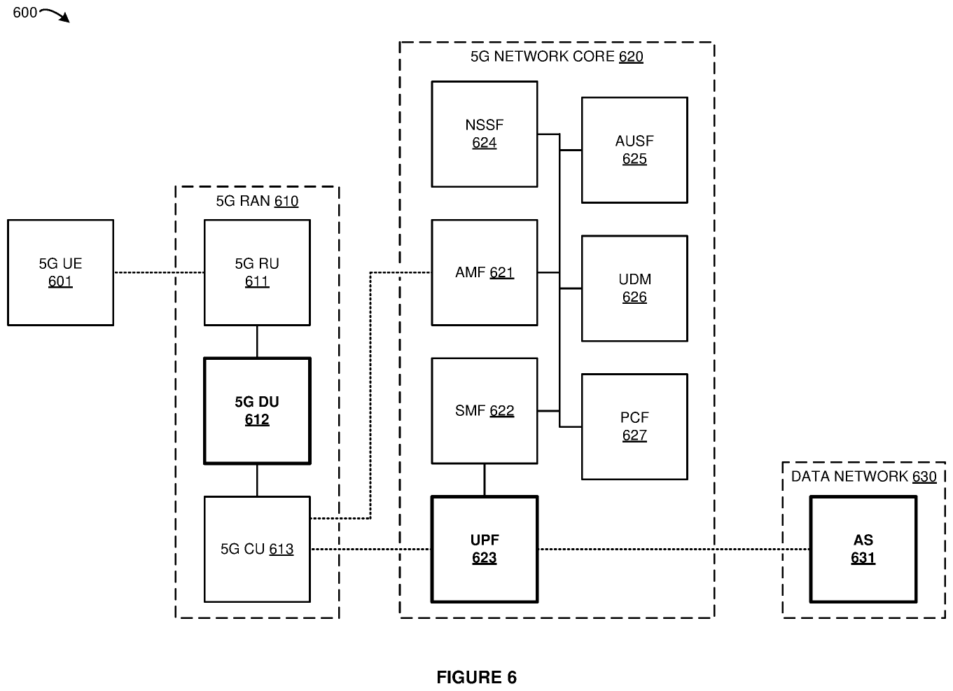

FIG. 6 illustrates 5G communication network 600 to proactively notify congestion control systems in response to downlink data congestion. 5G communication network 600 comprises an example of wireless communication networks 100 and 300, although networks 100 and 300 may differ. 5G communication network 600 comprises 5G UE 601, 5G RAN 610, 5G network core 620, and data network 630. 5G RAN 610 comprises 5G Radio Unit (RU) 611, 5G Distributed Unit (DU) 612, and 5G Centralized Unit (CU) 613. 5G network core 620 comprises AMF 621, SMF 622, UPF 623, Network Slice Selection Function (NSSF) 624, Authenticating Server Function (AUSF) 625, Unified Data Management (UDM) 626, and Policy Control Function (PCF) 627. Data network 630 comprises L4S capable Application Server (AS) 631. Other network functions and network elements are typically present in 5G network core 620 but are omitted for clarity. In other examples, wireless network communication network 600 may comprise additional or different elements than those illustrated in FIG. 6.

UE 601 wirelessly attaches to CU 613 via DU 612 and RU 611. UE 601 exchanges attachment signaling with CU 613 to establish a connection with 5G network applications hosted by CU 613. UE 601 transfers a registration request that indicates a registration type, UE capabilities, requested slice types, and Protocol Data Unit (PDU) session requests to AMF 621 over RAN 610. For example, UE 601 may execute a live video upload application, an XR application, an MR application, a VR application, an AR application, or some other type of latency sensitive application and responsively transfer the registration request. CU 613 transfers the registration request for UE 601 to AMF 621. AMF 621 responds to the registration request by transferring an identity request to UE 601 via RAN 610. UE 601 indicates its identity to AMF 621 via RAN 610. AMF 621 interacts with AUSF 625, UDM 626, and PCF 627 to authenticate and authorize UE 601 for wireless data service.

Responsive to the authentication and authorization, AMF 621 generates UE context to establish the wireless data service. AMF 621 retrieves Quality-of-Service (QoS) metrics, slice Identifiers (IDs), service attributes, and the like from UDM 626. AMF 621 interacts with NSSF 624 to select a network slice for UE 601. AMF 621 selects SMF 622 to serve UE 601 based on the slice ID, QoS metrics, the service attributes, and the requested PDU sessions. SMF 622 selects UPF 623 based on the service information provided by UDM 626 and the slice ID. SMF 622 interfaces with UPF 623 and AS 631 to set up the requested PDU sessions, including a low-latency PDU session. SMF 622 indicates the network addresses for UPF 623 and AS 631 to AMF 621. AMF 621 generates UE context for UE 601 using the received information. The UE context comprises the QoS metrics, the slice ID(s), the network addresses, the service attributes, and the like. AMF 621 transfers the UE context to UE 601 over RAN 610. UE 601 receives the UE context and uses the network addresses for UPF 623 and AS 631 to begin the PDU sessions. UE 601 transfers uplink user data to UPF 623 over RAN 610. UPF 623 transfers the uplink user data to AS 631. AS 631 generates and transfers downlink user data for the PDU sessions to UPF 623. UPF 623 transfers the downlink to UE 601 over RAN 610.

DU 612 monitors downlink data congestion in RAN 610 for transmissions to 5G UE 601. To monitor downlink congestion, DU 612 detects when downlink data queues form. Typically, this occurs when the number of required resource blocks to transmit the downlink data is less than the number of available resource blocks for a given time period. For example, DU 612 may host a congestion detection network application. The congestion detection application performs ECN marking on downlink data packets. When the internal ECN counter of the congestion detection application exceeds a preconfigured threshold, the congestion detection application inserts a congestion indication marker into an uplink packet. RAN 610 transfers the marked uplink packet to UPF 623 which forwards the marked packet to AS 631. DU 612 may measure and report additional queue attributes like the amount of queued data, the current data rate, a delta between expected and current data rate, estimated delay time, latency, and/or other information that characterizes queued downlink data.

AS 631 receives the congestion indication generated by RAN 610 and implements a congestion control scheme, typically by executing a congestion control algorithm. The congestion control algorithm takes inputs like queue existence, queue size, current data rate, target latency, and the like. The congestion control algorithm generates a congestion control output based on the inputs. In some examples, the congestion control output may comprise a downlink data priority that ranks the active PDU sessions for UE 601 by their latency requirements. Generally, latency sensitive PDU sessions are ranked higher than non-latency sensitive PDU sessions. AS 631 may then transfer downlink data for the PDU sessions based on the ranks (e.g., transferring downlink data for higher ranked sessions before transferring downlink data lower ranked sessions). In some examples, AS 631 may modify the data rates for the PDU sessions based on the ranks. For example, AS 631 may maintain the data rate of a higher ranked PDU session and reduce the data rate for a lower ranked PDU session. AS 631 may then transfer downlink data for the PDU sessions using the rank-based data rates. In some examples, the congestion control output may comprise a data rate reduction. AS 631 may then transfer downlink data at the reduced data indicated by the congestion control output to meet the latency requirements of the latency sensitive PDU sessions and reduce the amount of queued downlink data in RAN 610. In some examples, the congestion control output may comprise a temporary stoppage of downlink data and a time-to-wait period before resuming downlink transmission. AS 631 may then cease transmitting data and set a timer based on the time-to-wait period (e.g., 5 seconds) to clear the queue in RAN 610. After expiration of the timer, AS 631 may resume transferring the downlink data for the PDU sessions. It should be appreciated that the above congestion control schemes are exemplary and may vary in other examples.

Returning to the operation, UE 601 transfers uplink user data to UPF 623 over RAN 610. UPF 623 transfers the uplink user data to AS 631. AS 631 generates and transfers downlink user data for the PDU sessions to UPF 623 based on the congestion control output. UPF 623 transfers the downlink data to UE 601 over RAN 610. By directly notifying L4S capable AS 631 of the uplink congestion, AS 631 can modify its downlink data transmissions thereby alleviating downlink RAN congestion without having to report the RAN congestion to UE 601. Moreover, by reporting directly to AS 631, UE 601 is not required to comprise L4S congestion control functionality.

In some examples, UPF 623 monitors downlink data congestion in RAN 610 for transmissions to 5G UE 601 in place of or in addition to DU 612. To monitor downlink congestion, UPF 623 may measure the amount of downlink data transferred to RAN 610. UPF 623 may host a data structure that correlates the amount of data transferred for a given time period to a downlink data queue. UPF 623 inputs the amount of transferred downlink data for a given time period into the data structure to generate a queue indication that comprises the queue status of RAN 610 (e.g., if downlink queue exists or does not exist). UPF 623 inserts the queue indication into a message header of an uplink data packet for delivery to AS 631 and forwards the marked packet to AS 631.

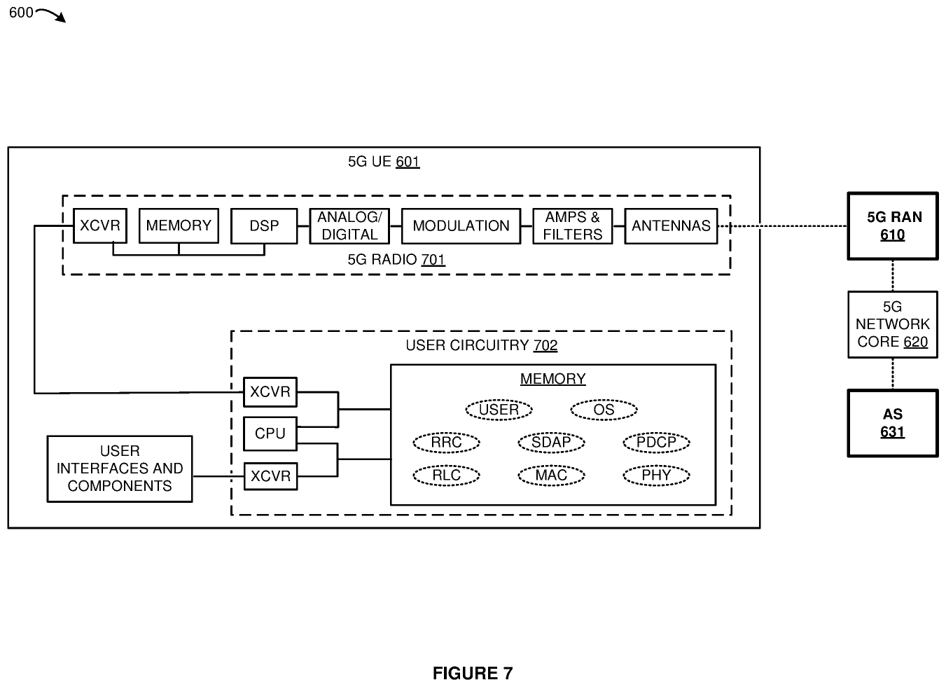

FIG. 7 illustrates 5G UE 601 in 5G communication network 600. UE 601 comprises an example of user device 101 illustrated in FIG. 1 and UE 301 illustrated in FIG. 3, however user device 101 and UE 301 may differ.

UE 601 comprises 5G radio 701 and user circuitry 702. Radio 701 comprises antennas, amplifiers, filters, modulation, analog-to-digital interfaces, Digital Signal Processers (DSP), memory, and transceivers (XCVRs) that are coupled over bus circuitry. User circuitry 702 comprises memory, CPU, user interfaces and components, and transceivers that are coupled over bus circuitry. The memory in user circuitry 702 stores an operating system (OS), user applications (USER), and 5GNR network applications for Physical Layer (PHY), Media Access Control (MAC), Radio Link Control (RLC), Packet Data Convergence Protocol (PDCP), Service Data Adaptation Protocol (SDAP), and Radio Resource Control (RRC). The antenna in radio 701 is wirelessly coupled to 5G RAN 610 over a 5GNR link. A transceiver in radio 701 is coupled to a transceiver in user circuitry 702. A transceiver in user circuitry 702 is typically coupled to the user interfaces and components like displays, controllers, and memory.

In radio 701, the antennas receive wireless signals from 5G RAN 610 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 702 over the transceivers. In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 610 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

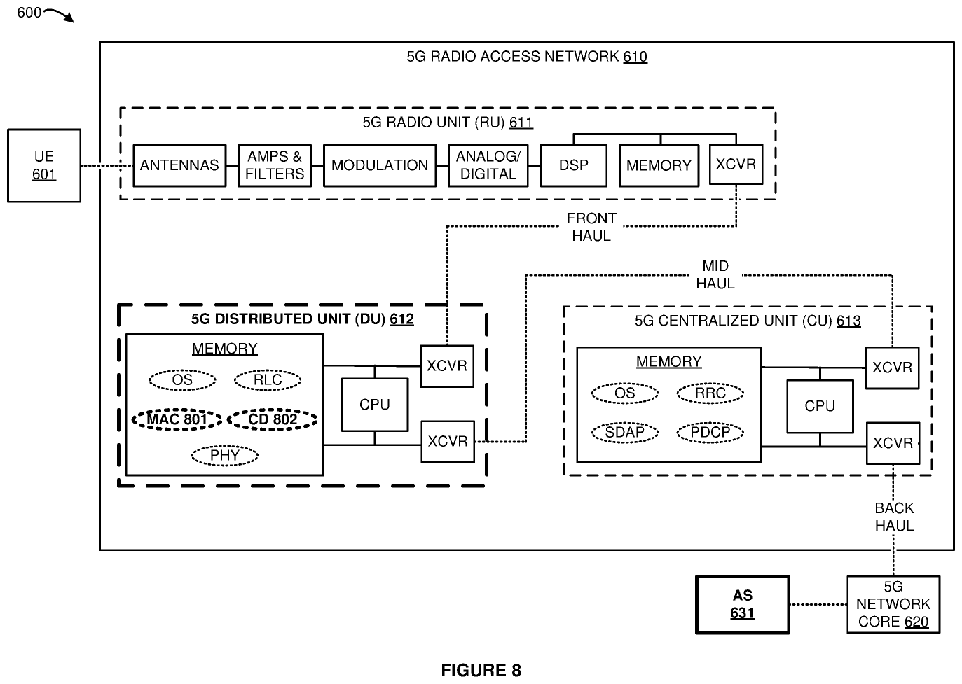

FIG. 8 illustrates 5G RU 611, 5G DU 612, and 5G CU 613 in 5G communication network 600. RU 611, DU 612, and CU 613 comprise an example of access node 110 illustrated in FIG. 1 and RAN 310 illustrated in FIG. 3, however access node 110 and RAN 310 may differ.

RU 611 comprises antennas, amplifiers, filters, modulation, analog-to-digital interfaces, DSP, memory, and transceivers (XCVRs) that are coupled over bus circuitry. UE 601 is wirelessly coupled to the antennas in RU 611 over 5GNR links. Transceivers in 5G RU 611 are coupled to transceivers in 5G DU 612 over fronthaul links like enhanced Common Public Radio Interface (eCPRI). The DSPs in RU 611 executes their operating systems and radio applications to exchange 5GNR signals with UE 601 and to exchange 5GNR data with DU 612.

For the uplink, the antennas receive wireless signals from UE 601 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 612 over the transceivers.

For the downlink, the DSPs receive downlink 5GNR symbols from DU 612. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink 5GNR signaling and data.

DU 612 comprises memory, CPU, and transceivers that are coupled over bus circuitry. The memory in 5G DU 612 stores operating systems and 5GNR network applications like PHY, MAC 801, Congestion Detection (CD) 802, and RLC. CU 613 comprises memory, CPU, and transceivers that are coupled over bus circuitry. The memory in CU 613 stores an operating system and 5GNR network applications like PDCP, SDAP, and RRC. Transceivers in 5G DU 612 are coupled to transceivers in RU 611 over front-haul links. Transceivers in DU 612 are coupled to transceivers in CU 613 over mid-haul links. A transceiver in CU 613 is coupled to network core 620 over backhaul links.

RLC functions comprise ARQ, sequence numbering and resequencing, segmentation and resegmentation. MAC 801 functions comprise buffer status, power control, channel quality, HARQ, user identification, random access, user scheduling, QoS, and Bottleneck Report (BNR) generation. CD 802 functions include congestion detection, packet marking, and queue measuring. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

In some examples, MAC 801 schedules downlink and uplink user data for PDU sessions, including an L4S PDU session for UE 601. The PHY exchanges uplink and downlink resource blocks based on the scheduling provided by MAC 801 with UE 601. The radio circuitry in RU 611 wirelessly transfers/receives the resource blocks to and from UE 601. MAC 801 indicates queuing delays and queue status for downlink data transmissions to CD 802. CD 802 monitors the severity of the queueing status for the downlink data transfer. CD 802 compares the amount of available downlink resource blocks to the amount of required downlink resource blocks for a given time interval. CD 802 determines a data queue exists or predicts a data queue will form when the amount of required resource blocks exceeds the amount of available resource blocks for the time interval. For example, CD 802 may determine MAC 801 can schedule 50 resource blocks in the next 50 ms, that 100 resource blocks worth of downlink data needs to be transferred in the next 50 ms, and responsively determine the existence of a data queue. In some examples, CD 802 may comprise ECN functionality. CD 802 may maintain an ECN counter that tracks the amount of downlink congestion in RAN 610. When the ECN counter exceeds a threshold value, CD 802 determines a downlink data queuing event will impact the latency of the L4S PDU session of UE 601. When CD 802 detects downlink data queuing, CD 802 inserts a congestion indication bit into the message header of an uplink data packet(s) for the L4S PDU session. MAC 801 schedules the uplink data packet with the congestion indication for transfer to UPF 623. The other network applications in DU 612 and CU 613 like RLC, PDCP, and SDAP transfer the uplink data that includes the congestion indication to UPF 623.

In some examples, MAC 801 and CD 802 generate a BNR that further characterizes the downlink congestion in RAN 610. After CD 802 detects the existence of the downlink queue, CD 802 measures queue attributes like queue size, latency, data rate, estimated queue time, amount of queued L4S data for UE 601, and the like. CD 802 indicates the existence of the queue and the measured queue attributes to MAC 801. MAC 801 and CU 802 may generate BNRs periodically, semi-periodically, randomly, and/or in response to detecting a queue to inform AS 631 of the downlink congestion status of RAN 610. For example, MAC 801 and CU 802 may generate and transfer a BNR once every five minutes. Generally, the queue attributes measured by MAC 801 and CD 802 correspond to the algorithm inputs used by the congestion control algorithm implemented by AS 631.

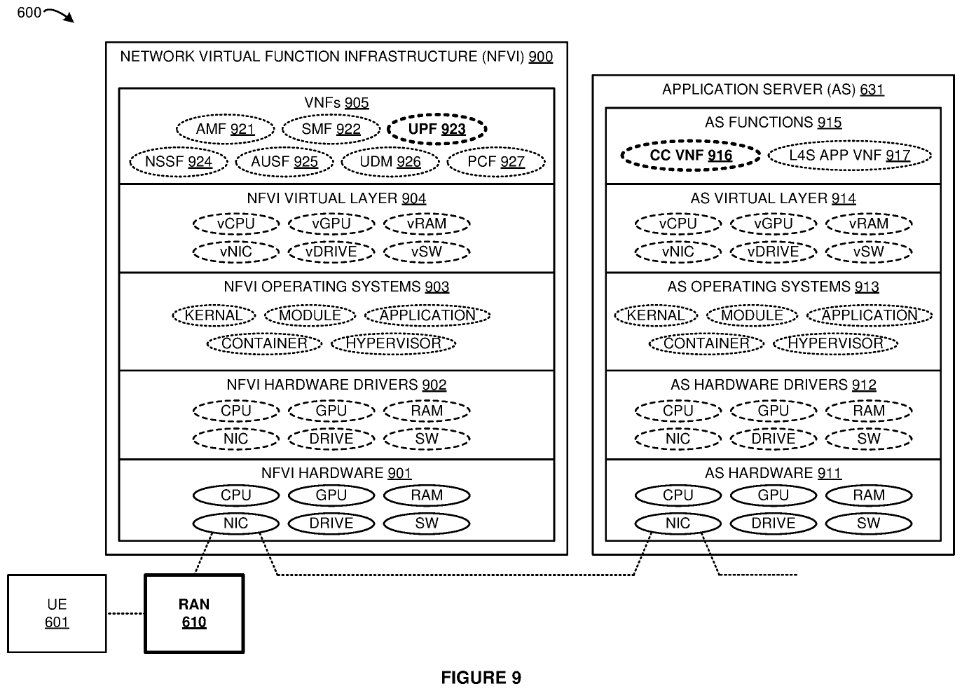

FIG. 9 illustrates Network Function Virtualization Infrastructure (NFVI) 900 and AS 631. NFVI 900 comprises an example of core network 121 illustrated in FIG. 1 and network circuitry 320 illustrated in FIG. 3, although core network 121 and network circuitry 320 may differ. NFVI 900 comprises NFVI hardware 901, NFVI hardware drivers 902, NFVI operating systems 903, NFVI virtual layer 904, and NFVI VNFs 905. NFVI hardware 901 comprises Network Interface Cards (NICs), CPU, GPU, RAM, Flash/Disk Drives (DRIVE), and Data Switches (SW). NFVI hardware drivers 902 comprise software that is resident in the NIC, CPU, GPU, RAM, DRIVE, and SW. NFVI operating systems 903 comprise kernels, modules, applications, containers, hypervisors, and the like. NFVI virtual layer 904 comprises vNIC, vCPU, vGPU, vRAM, vDRIVE, and vSW. NFVI VNFs 905 comprise AMF 921, SMF 922, UPF 923, NSSF 924, AUSF 925, UDM 926, and PCF 927. Additional VNFs and network elements like Network Repository Function (NRF), Network Exposure Function (NEF), and Unified Data Repository (UDR) are typically present but are omitted for clarity. NFVI 900 may be located at a single site or be distributed across multiple geographic locations. The NIC in NFVI hardware 901 is coupled to RAN 610 and to a NIC in AS 931. NFVI hardware 901 executes NFVI hardware drivers 902, NFVI operating systems 903, NFVI virtual layer 904, and NFVI VNFs 905 to form AMF 621, SMF 622, UPF 623, NSSF 624, AUSF 625, UDM 626, and PCF 627.

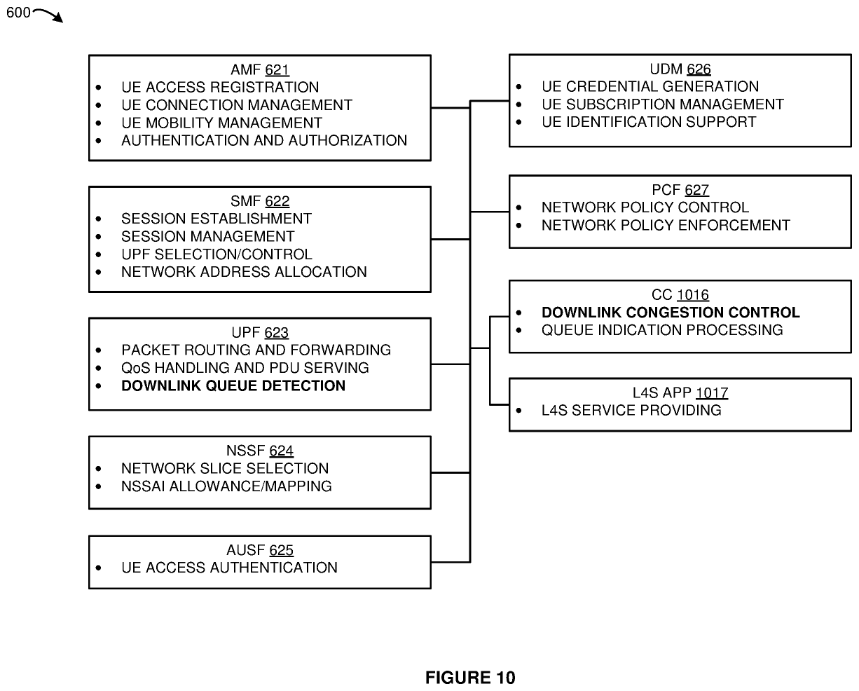

AS 631 comprises an example of AS 131 illustrated in FIG. 1 and AS 331 illustrated in FIG. 3, although AS 131 and AS 331 may differ. AS 631 comprises AS hardware 911, AS hardware drivers 912, AS operating systems 913, AS virtual layer 914, and AS functions 915. AS hardware 911 comprises NICs, CPU, GPU, RAM, DRIVE, and SW. AS hardware drivers 912 comprise software that is resident in the NIC, CPU, GPU, RAM, DRIVE, and SW. AS operating systems 913 comprise kernels, modules, applications, containers, hypervisors, and the like. AS virtual layer 914 comprises vNIC, vCPU, vGPU, vRAM, vDRIVE, and vSW. AS functions 915 comprise Congestion Control (CC) VNF 916 and L4S application (APP) VNF 917. Additional AS VNFs and network elements are typically present but are omitted for clarity. AS 631 may be located at a single site or be distributed across multiple geographic locations. The NIC in AS hardware 911 is coupled to the NIC in NFVI hardware 901 and to external systems. AS hardware 911 executes AS hardware drivers 912, AS operating systems 913, AS virtual layer 914, and AS functions 915 to form CC 1016 and L4S application 1017 illustrated in FIG. 10.

FIG. 10 further illustrates NFVI 900 and AS 631 in 5G communication network 600. AMF 621 comprises functionality for UE access registration, UE connection management, UE mobility management, and authentication and authorization. SMF 622 comprises functionality for session establishment, session management, UPF selection and control, and network address allocation. UPF 623 comprises functionality for packet routing and forwarding, QoS handling and PDU serving, and downlink queue detection. NSSF 623 comprises functionality for network slice selection and Network Slice Selection Assistance Information (NSSAI) allowance and mapping. AUSF 625 comprises functionality for UE access authentication. UDM 626 comprises functionality for UE credential generation, UE subscription management, and UE identification support. PCF 627 comprises functionality for network policy control and network policy enforcement. CC 1016 comprises functionality for downlink congestion control and queue indication processing. L4S application 1017 comprises functionality for L4S data service providing.

In operation, AMF receives a registration request for UE 601 from RAN 610. The registration request comprises a registration type, UE capabilities, requested slice types, and PDU session requests for a low-latency video conferencing data session. AMF 621 responds to the registration request by transferring an identity request to UE 601 via RAN 610. AMF 621 receives an identity indication from UE 601 via RAN 610 and interacts with AUSF 625, UDM 626, and PCF 627 to authenticate and authorize UE 601 for wireless data service. Responsive to the authentication and authorization, AMF 621 generates UE context to establish the wireless data service. AMF 621 retrieves service attributes for UE 601 from UDM 626. AMF 621 interacts with NSSF 624 to select a network slice for UE 601. AMF 621 selects SMF 622 to serve UE 601 based on the slice ID, the service attributes, and the PDU session type. SMF 622 selects UPF 623 to establish the video conferencing PDU session for UE 601. SMF 622 indicates the network addresses for UPF 623 and AS 631 to AMF 621. AMF 621 generates UE context for UE 601 comprising the service attributes, the slice ID, and the network addresses. AMF 621 transfers the UE context to UE 601 over RAN 610. UPF 623 exchanges downlink and uplink user data for the video conferencing PDU session with UE 601 over RAN 610. UPF 623 exchanges downlink and uplink user data for the video conferencing PDU session with L4S application 1017 in AS 631.

UPF 623 monitors downlink data congestion in RAN 610 for transmissions to 5G UE 601 in place of or in addition to DU 612. UPF 623 measures the amount of downlink data transferred to RAN 610 over a given time period. UPF 623 inputs the amount of transferred downlink data for a given time period into a data structure that correlates downlink data rates to RAN congestion conditions. The data structure outputs a queue indication that indicates the presence of a downlink data queue in RAN 610. UPF 623 transfers the queue indication to CC 1016 in AS 631.

CC 1016 receives the congestion indication generated by RAN 610 and inputs the indication into its congestion control algorithm. The congestion control algorithm may comprise a BBR algorithm that takes current latency, amount of queued data, queuing delay, and current data bit rate as inputs to generate a congestion response output. For example, CC 1016 may execute the following algorithm:

$$Congestion Output = ( A \times Latency ) + ( B \times QueueSize ) + ( C \times DataRate ) \qquad ( 1 )$$

where A, B, and C are coefficients to weight the Latency, QueueSize, and DataRate algorithm inputs. It should be appreciated that equation (1) is exemplary and may vary in other examples.

The congestion control algorithm generates a congestion control output based on the inputs. The congestion control output comprises a temporary stoppage of downlink data transmission, a time-to-wait period before resuming downlink transmission, and a reduced data rate. CC 1017 directs L4S application 1016 to implement the congestion control output. L4S application 1016 stops transferring downlink data for the video conferencing PDU session and sets an internal timer based on the indicated time-to-wait period. After expiration of the timer, L4S application 1016 generates and transfers additional downlink user data for the video conferencing PDU sessions at the reduced downlink data rate.

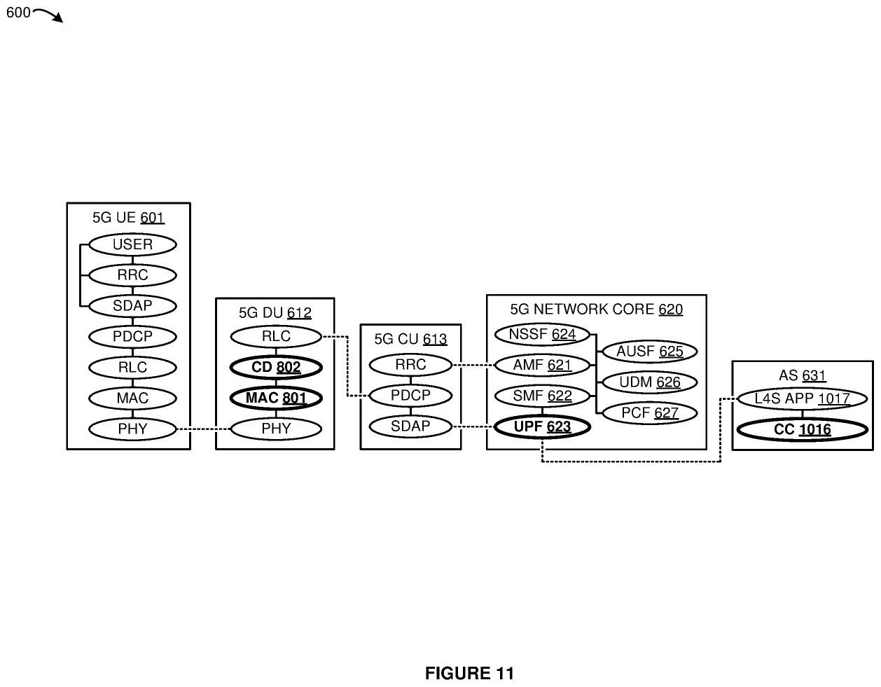

FIG. 11 illustrates an exemplary operation of 5G communication network 600 to proactively notify congestion control systems in response to downlink data congestion. The operation may vary in other examples. In operation, UE 601 executes a user application. In response, UE 601 wirelessly attaches to CU 613 via DU 612 and RU 611. The RRC in UE 601 exchanges attachment signaling with the RRC in CU 613 over the PDCPs, RLCs, MACs, and PHYs to establish an RRC connection. The RRC in UE 601 transfers a registration request comprising a registration type, UE capabilities, requested slice types, non-Guaranteed Bit Rate (GBR) PDU session requests, and a low-latency PDU session requests. The UE capabilities indicate UE 601 lacks L4S congestion control capabilities. The RRC in CU 613 records the UE capability information and transfers a registration request for UE 601 to AMF 621. AMF 621 responds to the registration request by transferring an identity request for UE 601 to the RRC in CU 613. The RRC in CU 613 forwards the identity request to the RRC in UE 601 over the PDCPs, RLCs, MACs, and PHYs. The RRC in UE 601 responds to the identity request by transferring an identity indication to the RRC in CU 613 over the PDCPs, RLCs, MACs, and PHYs. The RRC in CU 613 transfers the identity indication to AMF 621. AMF 621 interacts with AUSF 625, UDM 626, and PCF 627 to authenticate and authorize UE 601 for wireless data services.

Responsive to the authentication and authorization, AMF 621 retrieves QoS metrics, slice IDs, service attributes, and the like from UDM 626. AMF 621 interacts with NSSF 624 to select a network slice for UE 601. AMF 621 selects SMF 622 to serve UE 601 based on the slice ID, QoS metrics, the service attributes, and the requested PDU session types. SMF 622 selects UPF 623 based on the requested PDU session types and the slice ID and interfaces with L4S application 1017 to establish the requested PDU session types. SMF 622 indicates the network addresses for UPF 623 and AS 631 to AMF 621. AMF 621 generates UE context for UE 601 using the received information to establish the requested PDU sessions. The UE context comprises the QoS metrics, the slice ID, the network addresses, and the service attributes. AMF 621 transfers the UE context to the RRC in CU 613. The RRC in CU 613 transfers the UE context to the RRC in UE 601 over the PDCPs, RLCs, MACs, and PHYs.

The RRC in UE 601 receives the UE context and controls the SDAP in UE 601 to begin the non-GBR PDU sessions and the low-latency PDU session. The RRC indicates the network addresses for UPF 623 and AS 631 to the SDAP. The RRC directs the user application to begin the PDU sessions. The user application generates uplink user data for the non-GBR PDU session and generates uplink user data for the low-latency PDU session. The SDAP transfers the uplink user data for the non-GBR PDU session and the low-latency PDU session to the SDAP in CU 613 over the PDCPs, RLCs, MACs, and PHYs. The SDAP in CU 613 transfers the uplink user data to UPF 623 and UPF 623 transfers the uplink user data to L4S application 1017. L4S application 1017 generates downlink user data for the non-GBR PDU session and the low-latency PDU session. L4S application 1017 transfers the downlink user data to UPF 623. UPF 623 transfers the downlink to the SDAP in CU 613. The SDAP in CU 613 transfers the downlink user data to the SDAP in UE 601 over the PDCPs, RLCs, MACs, and PHYs.

MAC 801 monitors data congestion in RAN 610 for downlink transmissions to 5G UE 601. MAC 801 indicates the measured congestion attributes to CD 802. For example, MAC 801 may indicate the amount of available downlink air resources and the amount of needed air resources to CD 802. CD 802 maintains an internal ECN counter to predict downlink queue formation. Generally, as the ECN counter increases, the likelihood of a downlink data queue forming also increases. CD 802 increases the ECN counter in response to queueing events. For example, CD 802 may increase the ECN counter when the amount of needed air resources exceeds the amount of available air resources. When the ECN counter exceeds a threshold, CD 802 inserts a queue indication into a message header of an uplink data packet of the low-latency PDU session for delivery to AS 631 based on the reported UE capabilities. The SDAP in CU 613 transfers the uplink data that includes the congestion indication to UPF 623. UPF 623 transfers the uplink data that includes the congestion indication to CC 1016 over L4S application 1017.

CC 1016 reads the message header of the marked uplink data packet to detect the congestion indication. CC 1016 generates a congestion control response based on the congestion indication. For example, the congestion indication may indicate an amount of queued data, the latency, and the downlink data rate and CC 1016 may generate a congestion control response based on the amount of queued data, the latency, and the downlink data rate. CC 1016 directs L4S application 1017 to implement the congestion response. CC 1016 ranks the active PDU sessions for UE 601 by their latency requirements. Since the low-latency PDU session has a stricter latency requirement than the non-GBR PDU session, CC 1016 ranks the low-latency PDU session higher than the non-GBR PDU session. CC 1016 selects a lower downlink data rate for the non-GBR session based on its rank and maintains the downlink data rate for the low-latency PDU session based on its ranks. CC 1016 transfers a congestion control command that indicates the updated downlink data rate for the non-GBR PDU session to L4S application 1017.

L4S application 1017 generates and transfers additional downlink data to UPF 623 for the non-GBR PDU session and low-latency PDU session at the data rates indicated by the congestion control command to inhibit downlink congestion in RAN 610 and maintain the latency of the low-latency PDU session. UPF 623 transfers the additional downlink user data to the SDAP in CU 613. The SDAP in CU 613 transfers the additional downlink user data to the SDAP in UE 601 over the PDCPs, RLCs, MACs, and PHYs. The SDAP in UE 601 transfers additional uplink user data for the non-GBR PDU sessions and the low-latency PDU sessions to the SDAP in CU 613 over the PDCPs, RLCs, MACs, and PHYs. The SDAP in CU 613 transfers the additional uplink user data to UPF 623. UPF 623 transfers the additional uplink user data to L4S application 1017.

The wireless data network circuitry described above comprises computer hardware and software that form special-purpose network circuitry to proactively notify congestion control systems in response to downlink data congestion. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to proactively notify congestion control systems in response to downlink data congestion.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method of operating a wireless communication network to proactively notify congestion control systems in response to downlink data congestion, the method comprising:
an access node wirelessly exchanging user data with a wireless user device;
the access node exchanging the user data with a network user plane for delivery to an application server;
the access node detecting a data queue for downlink user data transferred by the application server and received from the network user plane;
the access node indicating the data queue to the network user plane for delivery to the application server;
the application server receiving the indication, generating additional user data, and transferring the additional user data based on a congestion control scheme;
the access node exchanging the additional user data with the network user plane for delivery to the application server; and
the access node wirelessly exchanging the additional user data with the wireless user device.

2. The method of claim 1 wherein:
the application server transferring the additional user data based on the congestion control scheme comprises determining a new downlink data rate based on the congestion indication and transferring the additional user data based on the new downlink data rate.

3. The method of claim 1 wherein:
the application server transferring the additional user data based on the congestion control scheme comprises executing a congestion control algorithm based on the congestion indication to generate a congestion control output and transferring the additional user data based on the congestion control output.

4. The method of claim 1 wherein:
a first portion of the user data comprises low latency data packets;
a second portion of the user data comprises other data packets; and
the application server transferring the additional user data based on congestion control scheme comprises determining a data priority that prioritizes the low latency data packets over the other data packets and transferring the additional user data based on data priority.

5. The method of claim 1 wherein:
a first portion of the user data comprises Low-Latency, Low Loss Scalable Throughput (L4S) data packets;
a second portion of the user data comprises other data packets; and
the application server transferring the additional user data based on congestion control scheme comprises determining a data priority that prioritizes the L4S data packets over the other data packets and transferring the additional user data based on the data priority.

6. The method of claim 1 further comprising:
the access node tracking an Explicit Congestion Notification (ECN) counter and determining when the ECN counter exceeds a threshold value; and
when the ECN counter exceeds the threshold value, the access node inserting a queue indicator into a message header of an uplink data packet; and wherein:
the access node indicating the data queue to the network user plane for delivery to the application server comprises transferring the uplink data packet that comprises the queue indicator to the network user plane for delivery to the application server.

7. The method of claim 1 wherein:
the access node detecting a data queue for downlink user data transferred by the application server and received from the network user plane comprises detecting a presence of the data queue, determining a downlink data latency, determining a downlink data rate, and determining an amount of queued downlink data; and
the access node indicating the data queue to the network user plane for delivery to the application server comprises generating and transferring a queue report that indicates the presence of the downlink data queue, the downlink data latency, the downlink data rate, and the amount of queued downlink data.

8. The method of claim 1 further comprising:
the access node executing a Media Access Control (MAC) network application;
the access node executing a Congestion Detection (CD) network application; and wherein:
the access node detecting the data queue for downlink user data transferred by the application server and received from the network user plane comprises the MAC detecting the data queue for the downlink user data transferred by the application server and received from the network user plane; and
the access node indicating the data queue to the network user plane for delivery to the application server comprises the CD indicating the data queue to the network user plane for delivery to the application server.

9. A wireless communication network configured to proactively notify congestion control systems in response to downlink data congestion, the wireless communication network comprising:
an access node configured to
wirelessly exchange user data with a wireless user device;
exchange the user data with a network user plane for delivery to an application server;
detect a data queue for downlink user data transferred by the application server and received from the network user plane; and
indicate the data queue to the network user plane for delivery to the application server;
the application server configured to:
receive the indication;
generate additional user data; and
transfer the additional user data based on a congestion control scheme; and
the access node configured to:
exchange the additional user data with the network user plane for delivery to the application server; and
exchange the additional user data with the wireless user device.

10. The wireless communication network of claim 9 wherein:
the application server is configured to determine a new downlink data rate based on the congestion indication and transfer the additional user data based on the new downlink data rate.

11. The wireless communication network of claim 9 wherein:
the application server is configured to execute a congestion control algorithm based on the congestion indication to generate a congestion control output and transfer the additional user data based on the congestion control output.

12. The wireless communication network of claim 9 wherein:
a first portion of the downlink data comprises low latency data packets;
a second portion of the downlink data comprises other data packets; and
the application server is configured to determine a data priority that prioritizes the low latency data packets over the other data packets and transfer the additional user data based on the data priority.

13. The wireless communication network of claim 9 wherein:
a first portion of the downlink data comprises Low-Latency, Low Loss Scalable Throughput (L4S) data packets;
a second portion of the downlink data comprises other data packets; and
the application server is configured to determine a data priority that prioritizes the L4S data packets over the other data packets and transfer the additional user data based on the data priority.

14. The wireless communication network of claim 9 wherein the access node is further configured to:
track an Explicit Congestion Notification (ECN) counter;
determine when the ECN counter exceeds a threshold value; and
when the ECN counter exceeds the threshold value, insert a queue indicator into a message header of an uplink data packet; and wherein:
the access node is configured to transfer the uplink data packet that comprises the queue indicator to the network user plane for delivery to the application server.

15. The wireless communication network of claim 9 wherein the access node is further configured to:
detect a presence of the data queue;
determine a downlink data latency;
determine a downlink data rate;
determine an amount of queued downlink data; and
generate and transfer a queue report for delivery to the application server that indicates the presence of the downlink data queue, the downlink data latency, the downlink data rate, and the amount of queued downlink data.

16. The wireless communication network of claim 9 wherein the access node is further configured to:
execute a Media Access Control (MAC) network application; and
execute a Congestion Detection (CD) network application; and wherein:
the MAC is configured to detect the data queue for downlink user data transferred by the application server and received from the network user plane; and
the CD is configured to indicate the data queue to the network user plane for delivery to the application server.

17. A method of operating a Radio Access Network (RAN) to proactively notify congestion control systems in response to downlink data congestion, the method comprising:
radio circuitry wirelessly exchanging user data with a wireless user device;
RAN circuitry exchanging the user data with a network user plane for delivery to an application server;
the RAN circuitry detecting a data queue for downlink user data transferred by the application server and received from the network user plane;
the RAN circuitry indicating the data queue to the network user plane for delivery to the application server wherein the application server receives the indication and transfers additional user data based on a congestion control scheme;
the RAN circuitry exchanging the additional user data with the network user plane for delivery to the application server; and
the radio circuitry wirelessly exchanging the additional user data with the wireless user device.

18. The method of claim 17 further comprising:
the RAN circuitry executing a Media Access Control (MAC) network application; and
the RAN circuitry executing a Congestion Detection (CD) network application.

19. The method of claim 18 further comprising:
the CD tracking an Explicit Congestion Notification (ECN) counter and determining when the ECN counter exceeds a threshold value;
when the ECN counter exceeds the threshold value, the CD inserting a queue indicator into a message header of an uplink data packet; and
the MAC transferring the uplink data packet that comprises the queue indicator to the network user plane for delivery to the application server.

20. The method of claim 17 wherein:
the RAN circuitry detecting the data queue for downlink user data transferred by the application server and received from the network user plane comprises detecting a presence of the data queue, determining a downlink data latency, determining a downlink data rate, and determining an amount of queued downlink data; and
the RAN circuitry indicating the data queue to the network user plane for delivery to the application server comprises generating and transferring a queue report that indicates the presence of the downlink data queue, the downlink data latency, the downlink data rate, and the amount of queued downlink data.
